(19) United States
(12) Patent Application Publication
(10) Pub. No.: US 2026/0211136 A1
(43) Pub. Date: Jul. 23, 2026

(54) SEISMIC VELOCITY PREDICTION USING DISPERSION IMAGES AND AUTOREGRESSIVE MACHINE LEARNING

(71) Applicant: SAUDI ARABIAN OIL COMPANY, Dhahran (SA)

(72) Inventors: Lu LIU, Beijing (CN); Hongwei LIU, Dhahran (SA)

(73) Assignees: ARAMCO FAR EAST (BEIJING) BUSINESS SERVICES CO., LTD., Beijing (CN); SAUDI ARABIAN OIL COMPANY, Dhahran (SA)

(21) Appl. No.: 18/719,564

(22) PCT Filed: Aug. 25, 2023
(86) PCT No.: PCT/CN2023/115012

§ 371 Date: Jun. 13, 2024

(51) Int. Cl. G01V 1/28; G01V 1/30

(52) U.S. Cl. CPC G01V 1/282; G01V 1/303

(57) ABSTRACT

Methods and systems are disclosed. The methods may include generating training pairs and training a machine learning (ML) model using the training pairs to produce a predicted seismic velocity profile from a dispersion image. The methods may further include obtaining seismic data from a subterranean region of interest, where the seismic data is sorted into gathers and, for each of the gathers, determining, using a transform, a dispersion image from each gather, inputting the dispersion image into the ML model, and producing a predicted seismic velocity profile from the ML model based on the dispersion image. The methods may still further include determining a predicted seismic velocity model using the predicted seismic velocity profile for each gather.

### BACKGROUND

During a seismic survey, seismic waves emitted from a seismic source may propagate along the surface of the earth and through a subterranean region of interest. Seismic waves that propagate along the surface of the earth are known as surface waves or ground roll. As the surface waves propagate, different frequencies of the surface waves may travel at different phase velocities. This separation phenomenon may be known as dispersion. A dispersion image may quantify dispersion.

It may be desirous to monitor the structural integrity of the subterranean region of interest to ensure civil engineering structures supported by the subterranean region of interest remain adequately supported over time. Civil engineering structures may include walkways, roads, railways, bridges, dams, and buildings. If the structural integrity of the subterranean region of interest is compromised, it may be advantageous to monitor the civil engineering structure it supports and/or formulate and execute a recovery plan for the civil engineering structure to mitigate damages.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method of training a machine learning (ML) model. The method includes generating training pairs, where each of the training pairs includes an mth training seismic velocity profile and an associated mth training dispersion image, and m is a count of the training pairs. Generating the training pairs includes collecting the mth training seismic velocity profile, generating an mth training seismic velocity model by extending the mth training seismic velocity profile along a dimension, determining, using forward modeling, mth training seismic data using the mth training seismic velocity model, and determining, using a transform, the associated mth training dispersion image using, at least in part, the mth training seismic data. The method further includes training the ML model using the training pairs. The ML model is trained to produce a predicted seismic velocity profile from a dispersion image.

In general, in one aspect, embodiments relate to a method of determining a predicted seismic velocity model. The method includes obtaining seismic data from a subterranean region of interest, where the seismic data is sorted into gathers. The method further includes, for each of the gathers, determining, using a transform, a dispersion image from each gather, inputting the dispersion image, at least in part, into a machine learning (ML) model, and producing a predicted seismic velocity profile from the ML model based, at least in part, on the dispersion image. The method still further includes determining the predicted seismic velocity model for the seismic data associated with the subterranean region of interest using the predicted seismic velocity profile for each gather.

In general, in one aspect, embodiments relate to a system. The system includes a seismic processing system configured to receive seismic data from a subterranean region of interest, where the seismic data is sorted into gathers. The seismic processing system is further configured to, for each of the gathers, determine, using a transform, a dispersion image from each gather, input the dispersion image, at least in part, into a machine learning (ML) model, and produce a predicted seismic velocity profile from the ML model based, at least in part, on the dispersion image. The seismic processing system is still further configured to determine a predicted seismic velocity model for the seismic data associated with the subterranean region of interest using the predicted seismic velocity profile for each gather.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 illustrates a seismic survey in accordance with one or more embodiments.

FIGS. 2A-2E each illustrates seismic waves in accordance with one or more embodiments.

FIGS. 2F-2J each illustrates seismic traces in accordance with one or more embodiments.

FIG. 3 displays a common shot gather in accordance with one or more embodiments.

FIG. 4 displays a synthetic seismic velocity model in accordance with one or more embodiments.

FIG. 5A displays an mth training seismic velocity profile in accordance with one or more embodiments.

FIG. 5B displays an mth training seismic velocity model in accordance with one or more embodiments.

FIG. 6 displays an associated mth training dispersion image in accordance with one or more embodiments.

FIG. 7 displays training seismic velocity profiles in accordance with one or more embodiments.

FIG. 8 illustrates a neural network in accordance with one or more embodiments.

FIG. 9 illustrates an architecture of a machine learning model in accordance with one or more embodiments.

FIG. 10 illustrates a workflow in accordance with one or more embodiments.

FIG. 11 describes a method in accordance with one or more embodiments.

FIG. 12 describes a method in accordance with one or more embodiments.

FIG. 13A displays a predicted seismic velocity model in accordance with one or more embodiments.

FIG. 13B displays a portion of the synthetic seismic velocity model in accordance with one or more embodiments.

FIG. 14 illustrates a computer system in accordance with one or more embodiments.

FIG. 15 illustrates systems in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a dispersion image” includes reference to one or more of such images.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

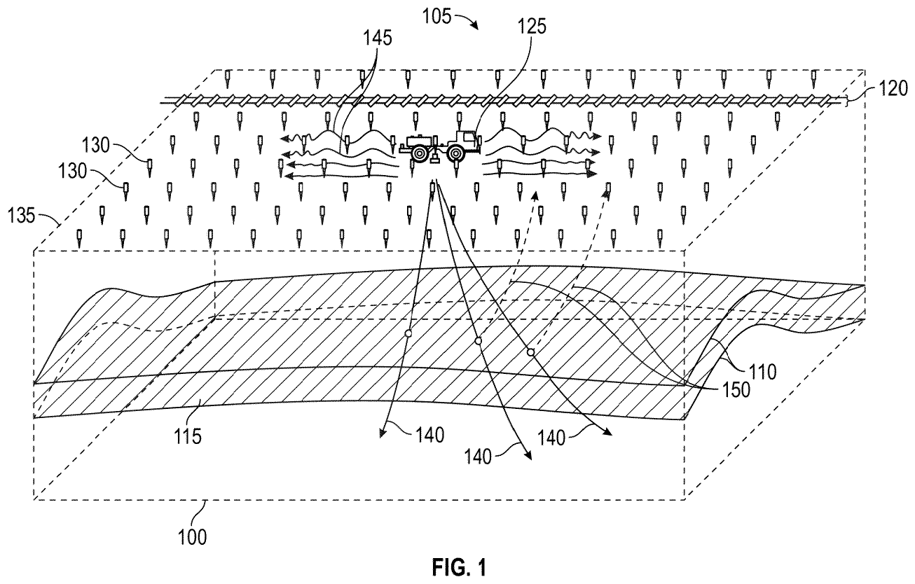

In the following description of FIGS. 1-15, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Methods and systems are disclosed to determine a predicted seismic velocity model from dispersion images using, at least in part, a machine learning (ML) model. To do so, dispersion images may be determined from seismic data. Each dispersion image may be input into the ML model to produce a predicted seismic velocity profile. The predicted seismic velocity profile determined from each dispersion image may then be combined to determine the predicted seismic velocity model. The ML model may be a series of neural networks and/or autoregressive.

The disclosed method may be an improvement over existing inversion methods used to determine a predicted seismic velocity model as existing inversion methods may be time consuming and computationally expensive in comparison to the disclosed method. As such, the disclosed method may be used to predict a seismic velocity model in real time, which may not be easily done using existing inversion methods.

In turn, real-time predicted seismic velocity models may be used to continuously monitor the structural integrity of a subterranean region of interest. For example, real-time predicted seismic velocity models may be used to monitor a subterranean region of interest that supports a civil engineering structure, such as a walkway, road, railway, skiway, bridge, dam, or building. Significant changes in the predicted seismic velocity model over time may indicate motion of the subterranean region of interest. In turn, motion could indicate a lack of structural integrity of the subterranean region of interest and/or future collapse of the civil engineering structure supported by the subterranean region of interest. In turn, interventions, such as a recovery plan, could be formulated to avoid injuring those who may be using the civil engineering structure and/or catastrophic failure of the civil engineering structure.

Turning to FIG. 1, FIG. 1 illustrates a seismic survey of a subterranean region of interest 100 in accordance with one or more embodiments. The seismic survey may be performed using a seismic acquisition system 105. The subterranean region of interest 100 may include geological boundaries 110 that separate rock layers 115. Further, the subterranean region of interest 100 may reside above and, thus, support a civil engineering structure, such as a skiway, walkway, road, and/or railway 120.

The seismic acquisition system 105 may include a seismic source 125 and seismic receivers 130 positioned on the surface of the earth 135. In some embodiments, the seismic source 125 may be a dynamite source or seismic vibrator (“vibroseis truck”) configured to emit seismic waves. In other embodiments, the seismic source 125 may be one or more vehicles traveling along the skiway, walkway, road, and/or railway 120. Vehicles may include, but are not limited to, ski mobiles, cars, trucks, and trains. The seismic waves 140 then propagate along ray paths as illustrated in FIG. 1. Some seismic waves 140 may propagate through the subterranean region of interest 100. Other seismic waves 140 may propagate along the surface of the earth 135 as direct waves or surface waves 145 (alternatively “ground roll”). Types of surface waves 145 include Love waves and Rayleigh waves. Other seismic waves 140 may propagate through the subterranean region of interest 100, reflect (and possibly refract) one or more times at geological boundaries 110, and return to the surface of the earth 135 as reflected seismic waves 150. Still other seismic waves 140 may propagate through the subterranean region of interest 100, refract (and possibly reflect) one or more times at geological boundaries 110, and continue propagating into the subterranean region of interest 100 as refracted seismic waves (not shown). Reflected seismic waves 150 and refracted seismic waves may be collectively referred to as body waves. Types of body waves include compressional waves (P-waves) and shear waves (S-waves).

Each seismic receiver 130 may be configured to record the ground motion caused by the seismic waves, including surface waves 145, as a time series known as a “seismic trace.” Each seismic trace may represent the amplitude of the ground motion caused by the seismic waves at a sequence of discrete times t beginning after the seismic waves are emitted from the seismic source 125. The collection of seismic traces recorded during the seismic survey may be referred to as “seismic data.” Hereinafter, seismic data may include seismic traces caused by surface waves 145, reflected seismic waves 150, and/or refracted seismic waves without departing from the scope of the disclosure.

A collection of seismic traces among the seismic data may be sorted such that the seismic traces within the collection share a common attribute. The collection of seismic traces sorted by a common attribute may be generally referred to as a “gather.” Types of gathers include, but are not limited to, a common shot gather, common receiver gather, common offset gather, common midpoint gather, and common depth point gather. Hereinafter, the generic term “gather” may be used to denote any type of gather. Further hereinafter, the seismic data includes seismic traces sorted into two or more gathers.

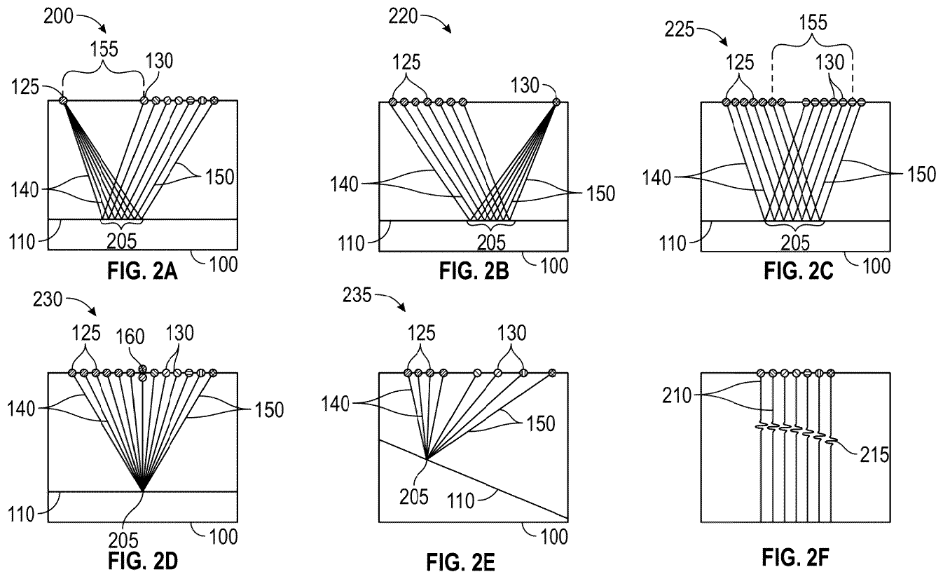

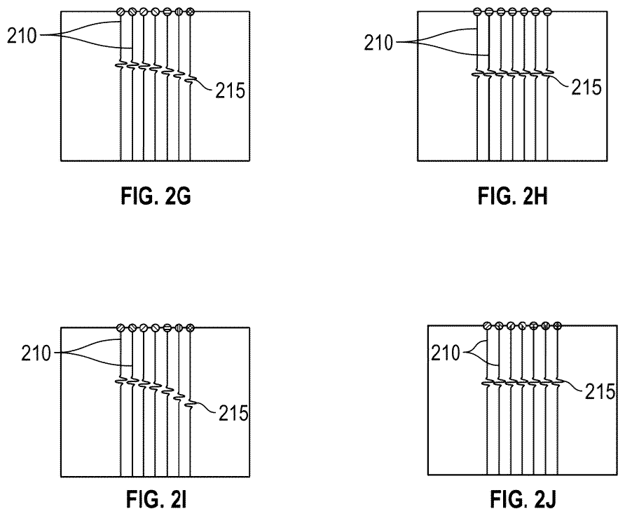

Each of FIGS. 2A-2E illustrates a collection of seismic waves 140 sorted by gather type in accordance with one or more embodiments. Each of FIGS. 2F-2J illustrates the associated collection of seismic traces sorted by each type of gather. While FIGS. 2A-2E only illustrate reflected seismic waves 150 in two spatial dimensions for clarity, a person of ordinary skill in the art will appreciate that any type of gather may include body waves and/or surface waves 145 in three spatial dimensions without departing from the scope of the disclosure.

FIG. 2A illustrates the sorting of a collection of seismic waves 140 for a common shot gather 200. In a common shot gather 200, each seismic wave 140 may radiate from a common seismic source 125, reflect at a geological boundary 110 within a subterranean region of interest 100 at one of several points 205, and be recorded by uncommon seismic receivers 130. Each seismic receiver 130 may be equally offset relative to neighboring seismic receivers 130. FIG. 2F illustrates a collection of seismic traces 210 that may be recorded for a common shot gather 200. Each seismic trace 210 is recorded by each seismic receiver 130. Each seismic trace 210 may indicate the propagation time of a seismic wave 140 emitted from a seismic source 125, reflected at the geological boundary 110, and detected by a seismic receiver 130 as a pulse 215. In a common shot gather 200, each pulse 215 in each seismic trace 210 may appear at increasing times with increasing source-receiver offsets 155 due to the increasing propagation distance. This phenomenon is known as “moveout.”

FIG. 2B illustrates the sorting of the collection of seismic waves 140 for a common receiver gather 220. In a common receiver gather 220, each seismic wave 140 may radiate from a separate location of a seismic source 125, reflect at the geological boundary 110 within the subterranean region of interest 100 at one of several points 205, and be recorded by a common seismic receiver 130. Each seismic source 125 may be equally offset relative to neighboring seismic sources 125. FIG. 2G illustrates a collection of seismic traces 210 that may be recorded for a common receiver gather 220. Again, each seismic trace 210 may indicate the propagation time of a seismic wave 140 emitted from a seismic source 125, reflected at the geological boundary 110, and detected by a seismic receiver 130 as a pulse 215. In a common receiver gather 220, each pulse 215 in each seismic trace 210 may appear at increasing times due to moveout.

FIG. 2C illustrates the sorting of the collection of seismic waves 140 for a common offset gather 225. In a common offset gather 225, each seismic wave 140 may radiate from a separate location of a seismic source 125, reflect at the geological boundary 110 within the subterranean region of interest 100 at one of several points 205, and be recorded at a separate location of a seismic receiver 130. Each seismic source 125 may be equally offset from neighboring seismic sources 125. Each seismic receiver 130 may also be equally offset relative to neighboring seismic receivers 130. However, the source-receiver offset 155 between each location of a seismic source 125 and the corresponding location of a seismic receiver 130 is fixed for all seismic traces 210 within the common offset gather 225. FIG. 2H illustrates a collection of seismic traces 210 that may be recorded for a common offset gather 225. Again, each seismic trace 210 may indicate the propagation time of a seismic wave 140 emitted from a seismic source 125, reflected at the geological boundary 110, and detected by a seismic receiver 130 as a pulse 215. In a common offset gather 225, each pulse 215 in each seismic trace 210 may appear at nearly the same time.

FIG. 2D illustrates the sorting of the collection of seismic waves 140 for a common midpoint gather 230. In a common midpoint gather 230, each seismic wave 140 may radiate from a separate location of a seismic source 125, reflect at the geological boundary 110 within the subterranean region of interest 100 at one point 205 (i.e., the common depth point), and be recorded by a separate location of a seismic receiver 130. Each seismic source 125 may be equally offset relative to neighboring seismic sources 125. Each seismic receiver 130 may also be equally offset relative to neighboring seismic receivers 130. However, the midpoint location (i.e., the common midpoint 160) between a seismic source 125 and corresponding location of a seismic receiver 130 is fixed within the common midpoint gather 230. FIG. 2I illustrates a collection of seismic traces 210 that may be recorded for a common midpoint gather 230. As with a common shot gather 200 and common receiver gather 220, each pulse 215 in each seismic trace 210 may appear at increasing times due to moveout.

FIG. 2E illustrates the sorting of the collection of seismic waves 140 for a common depth point gather 235. In a common depth point gather 235, each seismic wave 140 may radiate from a separate location of a seismic source 125, reflect at a geological boundary 110 with a dip within the subterranean region of interest 100 at one point 205 (i.e., the common depth point), and be recorded by separate locations of a seismic receiver 130. Each seismic source 125 may or may not be equally offset relative to neighboring seismic sources 125. FIG. 2J illustrates a collection of seismic traces 210 that may be recorded for a common depth point gather 235. As with a common offset gather 225, each pulse 215 in each seismic trace 210 may appear at nearly the same time.

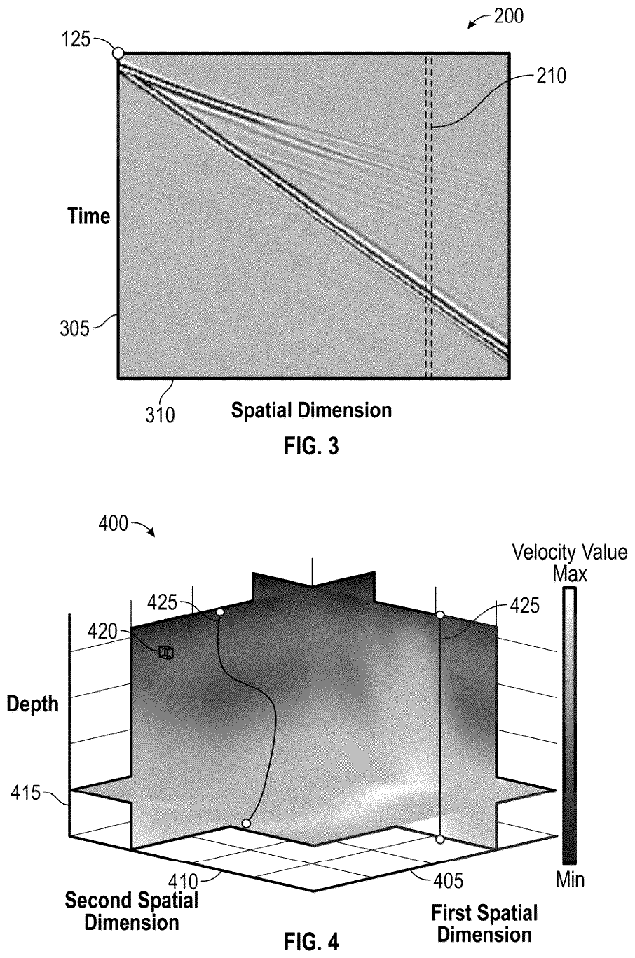

FIG. 3 displays a collection of seismic traces 210 sorted into a common shot gather 200 in accordance with one or more embodiments. Here, the seismic traces 210 include pulses 215 caused by both body waves and surface waves 145 following seismic waves 140 being emitted from a common seismic source 125. Because seismic traces 210 are recorded in a time domain, the ordinate 305 is denoted time. The abscissa 310 is denoted spatial dimension, which may be a distance away from the seismic source 125. While FIG. 3 illustrates a synthetic common shot gather 200 generated using a process known as forward modeling, the common shot gather 200 may alternatively be recorded during a seismic survey as described in FIG. 1.

Synthetic seismic data, and, thus, synthetic gathers, may be determined by applying forward modeling to a previously determined seismic velocity model that represents a subterranean region of interest 100. The previously determined seismic velocity model may be an S-wave seismic velocity model, P-wave seismic velocity model, or combination thereof. For example, the synthetic common shot gather 200 displayed in FIG. 3 is generated from an open-source synthetic seismic velocity model. FIG. 4 displays a smoothed version of the synthetic seismic velocity model 400 in accordance with one or more embodiments. The abscissa 405 denotes a first spatial dimension, the ordinate 410 denotes a second spatial dimension, and the applicate 415 specifically denotes the spatial dimension of depth. Each model position 420 is assigned a seismic velocity value (hereinafter also simply “velocity value”) as shown by the grayscale bar.

In the context of this disclosure, forward modeling may be the process of solving or approximating physics-based equations that govern the relationship between seismic data and a seismic velocity model. For example, forward modeling may be the process of solving the elastic wave equation to simulate how seismic waves 140 propagate along boundaries of and through the subterranean region of interest 100 based on the synthetic seismic velocity model 400. The synthetic seismic data determined from forward modeling may look similar to the seismic data collected from the seismic survey described in FIG. 1. Further, the synthetic seismic data may be organized into gathers as described in FIGS. 2A-3E.

In some embodiments, a previously determined seismic velocity model may also be used to collect two or more mth training seismic velocity profiles, where m is a count further discussed below. Each mth training seismic velocity profile may also be generically referred to as simply a training seismic velocity profile. In some embodiments, an mth training seismic velocity profile may be a sequence of velocity values collected along a line 425 that intersects a seismic velocity model as shown in FIG. 4. In some embodiments, the line 425 may span a single spatial dimension of the seismic velocity model. In other embodiments, the line 425 may span two or three spatial dimensions of the seismic velocity model and may not be linear.

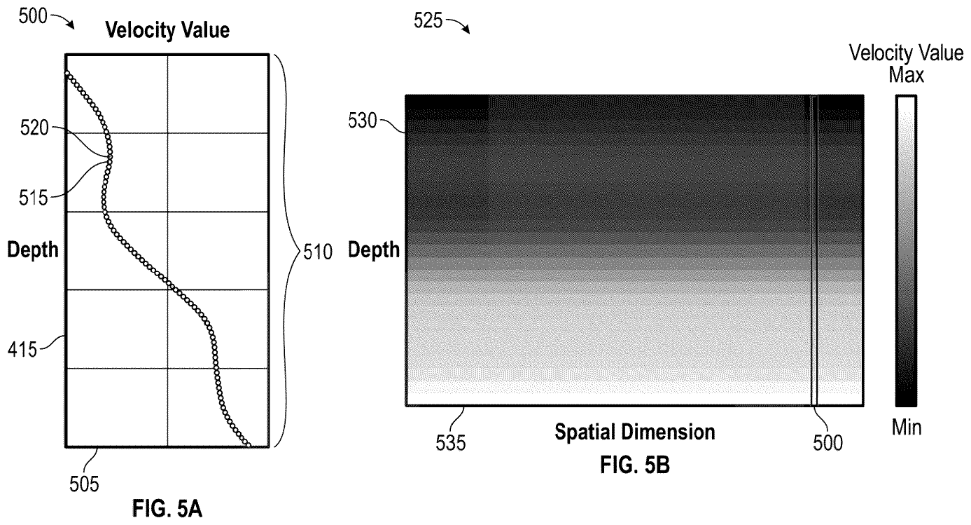

FIG. 5A illustrates an mth training seismic velocity profile 500 collected from the synthetic seismic velocity model 400 along a line 425 in accordance with one or more embodiments. In FIG. 5A, the applicate 415 is the spatial dimension of depth while the abscissa 505 is velocity value. The mth training seismic velocity profile 500 includes a sequence of velocity values 510 extracted from the synthetic seismic velocity model 400 along a line 425 organized by depth. As such, a velocity value located at a deep depth 515 resides deeper within the subterranean region of interest 100 than a velocity value located at a shallow depth 520.

The mth training seismic velocity profile 500 may be extended along a spatial dimension to generate an mth training seismic velocity model 525 as illustrated in FIG. 5B. In FIG. 5B, the applicate 530 remains the spatial dimension of depth. The abscissa 535 is now the spatial dimension that is extended. The velocity value is now shown by the grayscale bar. The mth training seismic velocity model 525 as displayed in FIG. 5B may be described as a laterally homogeneous seismic velocity model. However, a person of ordinary skill in the art will appreciate that the mth training seismic velocity model 525 may not always be a laterally homogeneous seismic velocity model.

Forward modeling may be applied to the mth training seismic velocity model 525 to determine synthetic seismic data organized by synthetic gather denoted mth training synthetic seismic data. The synthetic seismic traces 210 within the mth training synthetic seismic data may look similar to the synthetic seismic traces 210 displayed in the synthetic common shot gather 200 displayed in FIG. 3.

The mth training synthetic seismic data may include synthetic seismic traces 210 recorded due to surface waves 145 and body waves. As such, mth training synthetic surface wave data may be extracted from the mth training synthetic seismic data to remove the body waves, if present. Any method known to a person of ordinary skill in the art may be used. For example, any filtering method may be used such as, but not limited to, low-pass filtering, frequency-wavenumber (f-k) filtering, velocity filtering, and adaptive filtering.

A transform may then be applied to the mth training synthetic surface wave data to determine an associated mth training synthetic dispersion image. Any transform known to a person of ordinary skill in the art may be used. Transforms include, but are not limited to, a Radon transform, f-k transform, and phase-shift method. Note that forward modeling and seismic inversion, described below, as well as the application of filters and transforms to any seismic data may be generically referred to as “seismic processing.”

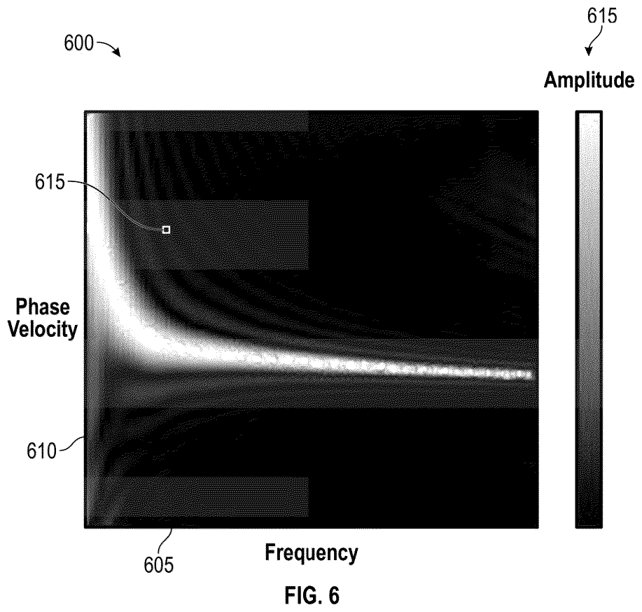

FIG. 6 illustrates an associated mth training synthetic dispersion image 600 in accordance with one or more embodiments. Dispersion may be defined as a phenomenon where seismic waves of different frequencies travel at different phase velocities. Body waves that propagate through the subterranean region of interest 100 may exhibit minimal dispersion. However, surface waves 145 that propagate along the surface of the earth 135 and near the surface of the earth 135 within the subterranean region of interest 100 may be dispersive. Surface waves 145 may be prone to disperse as low-frequency (i.e., long-wavelength) surface waves 145 penetrate deeper into the subterranean region of interest 100 where the phase velocity tends to be higher than in the near-surface rock layer 115.

The associated mth training synthetic dispersion image 600 may display the amplitude of surface waves 145 at each of a range of frequencies indicated by the abscissa 605 and each of a range of phase velocities indicated by the ordinate 610. The amplitude of the surface wave 145 at each frequency and phase velocity is indicated by the grayscale bar 615. Note that amplitude may be normalized. Hereinafter, an mth training seismic velocity profile 500, such as the one shown in FIG. 5A, and its associated mth training synthetic dispersion image 600, such as the one shown in FIG. 6, may be referred to as an mth training pair. In practice, tens to thousands of training pairs may be determined in the manner just described.

Various processes and/or models may be used to produce one or more seismic velocity profiles from a dispersion image. In some embodiments, an mth training seismic velocity profile may be collected from a seismic velocity model as previously described relative to FIG. 4. In other embodiments, an mth training seismic velocity profile may be determined using seismic inversion (hereinafter “inversion”). In the context of this disclosure, inversion may be the iterative process of determining the mth training seismic velocity profile based on a cost function. To do so, seismic data made up of gathers, as previously described relative to FIGS. 1 and 2A-2J, may be collected from a subterranean region of interest 100. A transform may be applied to each gather to determine an mth dispersion image. The mth dispersion image may used, at least in part, to form the cost function. After each iteration, an extremum of the cost function may be determined. The extremum may be used to perturb the mth seismic velocity profile that is currently unknown. As the iterations increase, the extremum of the cost function may move closer to a true extremum and the mth training seismic velocity profile may move closer to a true mth training seismic velocity profile. In some embodiments, inversion may be performed based on a deterministic genetic algorithm or other deterministic methods.

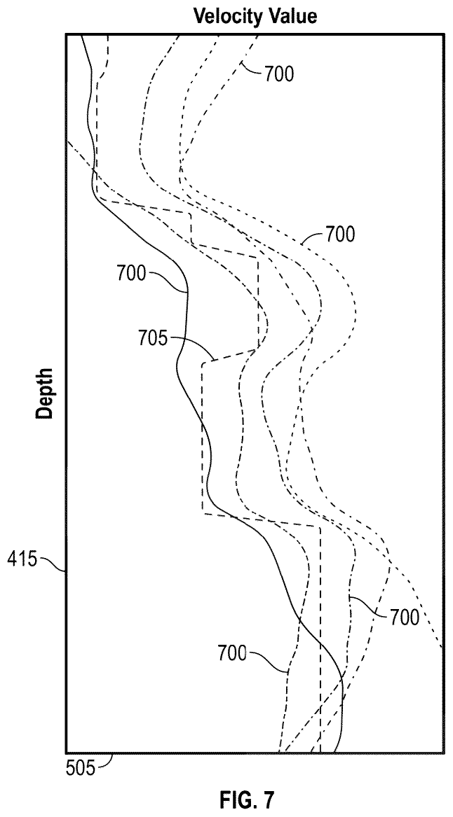

Further, in some embodiments, a model may be used to augment or increase the number of training seismic velocity profiles by generating one or more additional training seismic velocity profiles 700 from a previously-determined training seismic velocity profile 705 as displayed in FIG. 7. The one or more additional training seismic velocity profiles 700 may enhance the diversity and variability of the training seismic velocity profiles while maintaining the general trend of the previously-determined training seismic velocity profile 705 through data augmentation. In some embodiments, the model may take the form:

$$S = F ( {S}_{0} + {r}_{0} + {F}^{′} ( A \cdot R ) ) , \qquad Equation ( 1 )$$

where S is an additional training seismic velocity profile 700, S₀ is the previously-determined training seismic velocity profile 705, r₀ is a random number within a range, such as [−80,80], A is a linearly-increasing vector, R is a random vector where each random number is within a range, such as [−0.45, 0.55], and F and F′ are Gaussian smoothing operators with small and large windows, respectively.

In some embodiments, a predicted seismic velocity profile may be predicted from a dispersion image using an autoregressive process. In the context of this disclosure, autoregression may be defined as a process that, at least in part, predicts future values from known values and previously predicted values. In some embodiments, the known values may be the dispersion image. The previously predicted values may be one or more previously predicted velocity values each located at a shallow depth 520 within the predicted seismic velocity profile as illustrated in FIG. 5A. The future values may be a velocity value at a deep depth 515 within the predicted seismic velocity profile that has yet to be predicted. In other words, the predicted seismic velocity profile is being predicted one velocity value at a time in order of the sequence of velocity values 510. As such, an autoregressive process may inherently consider the spatial dependencies of the dispersion image and velocity values within the predicted seismic velocity profile.

An autoregressive process may be implemented within a machine learning model. Machine learning (ML), broadly defined, is the extraction of patterns and insights from data. The phrases “artificial intelligence,” “machine learning,” “deep learning,” and “pattern recognition” are often convoluted, interchanged, and used synonymously. This ambiguity arises because the field of “extracting patterns and insights from data” was developed simultaneously and disjointedly among a number of classical arts like mathematics, statistics, and computer science. For consistency, the term machine learning, or machine learned, will be adopted herein. However, one skilled in the art will recognize that the concepts and methods detailed hereafter are not limited by this choice of nomenclature.

In some embodiments, the ML model may be a convolutional neural network (CNN), a recurrent neural network (RNN), or both. A CNN and RNN may be more readily understood as specialized neural networks (NN). Thus, a cursory introduction to an NN is provided herein. However, note that many variations of an NN, CNN, and RNN exist. Therefore, one of ordinary skill in the art will recognize that any variation of an NN, CNN, or RNN (or any other ML model) may be employed without departing from the scope of the disclosure. Further, it is emphasized that the following discussions of an NN, CNN, and RNN are basic summaries and should not be considered limiting.

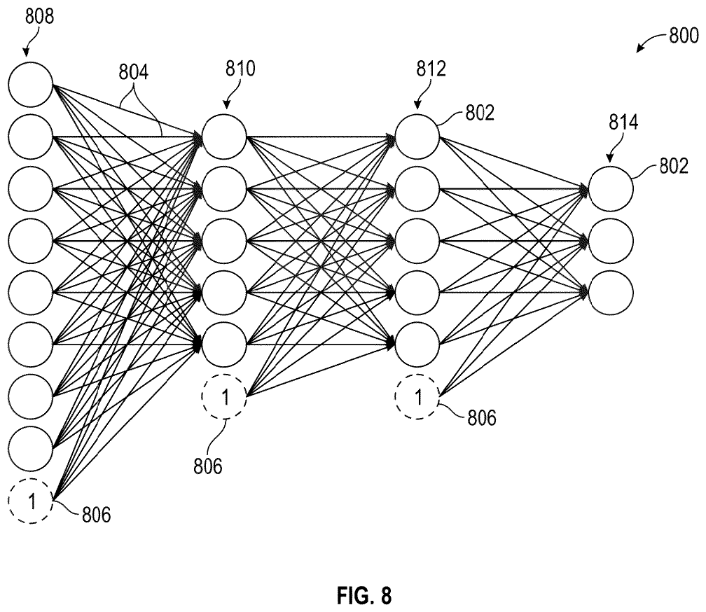

A diagram of an NN is shown in FIG. 8. At a high level, an NN 800 may be graphically depicted as being composed of nodes 802 and edges 804. The nodes 802 may be grouped to form layers. FIG. 8 displays four layers 808, 810, 812, 814 of nodes 802 where the nodes 802 are grouped into columns. However, each group need not be as shown in FIG. 8. The edges 804 connect the nodes 802 to other nodes 802. Edges 804 may connect, or not connect, to any node(s) 802 regardless of which layer 808, 810, 812, 814 the node(s) 802 is in. That is, the nodes 802 may be sparsely and residually connected. For example, in an RNN, nodes 802 in the output layer 814 may be connected by edges 804 to nodes 802 in the input layer 808 (though not shown in FIG. 8). As such, an RNN may be considered autoregressive.

An NN 800 will have at least two layers, where the first layer 808 is the “input layer” and the last layer 814 is the “output layer.” Any intermediate layer 810, 812 is usually described as a “hidden layer.” An NN 800 may have zero or more hidden layers 810, 812. An NN 800 with at least one hidden layer 810, 812 may be described as a “deep” neural network or “deep learning method.” In general, an NN 800 may have more than one node 802 in the output layer 814. In these cases, the neural network 800 may be referred to as a “multi-target” or “multi-output” network.

Nodes 802 and edges 804 carry associations. Namely, every edge 804 is associated with a numerical value. The edge numerical values, or even the edges 804 themselves, are often referred to as “weights” or “parameters.” While training an NN 800, a process that will be described below, numerical values are assigned to each edge 804. Additionally, every node 802 is associated with a numerical value and may also be associated with an activation function. Activation functions are not limited to any functional class, but traditionally follow the form:

$$A = f ( {\sum }_{i ∈ ( incoming )} [ {( node value )}_{i} {( edge value )}_{i} ] ) , \qquad Equation ( 2 )$$

where i is an index that spans the set of “incoming” nodes 802 and edges 804 and f is a user-defined function. Incoming nodes 802 are those that, when viewed as a graph (as in FIG. 8), have directed arrows that point to the node 802 where the numerical value is being computed. Some functions ƒ may include the linear function ƒ(x)=x, sigmoid function

$$f ( x ) = \frac{1}{1 + {e}^{- x}} ,$$

rectified linear unit function ƒ(x)=max(0,x), and softmax function

$${f ( x )}_{i} = \frac{{e}^{{x}_{i}}}{{\sum }_{j = 1}^{K} {e}^{{x}_{j}}} ,$$

however, many additional functions are commonly employed. Every node 802 in an NN 800 may have a different associated activation function. Often, as a shorthand, activation functions are described by the function ƒ by which it is composed. That is, an activation function composed of a linear function ƒ may simply be referred to as a linear activation function without undue ambiguity.

When the NN 800 receives an input, the input is propagated through the network according to the activation functions and incoming node values and edge values to compute a value for each node 802. That is, the numerical value for each node 802 may change for each received input while the edge values remain unchanged. Occasionally, nodes 802 are assigned fixed numerical values, such as the value of 1. These fixed nodes 806 are not affected by the input or altered according to edge values and activation functions. Fixed nodes 806 are often referred to as “biases” or “bias nodes” as displayed in FIG. 8 with a dashed circle.

In some implementations, the NN 800 may contain specialized layers, such as a normalization layer, pooling layer, or additional connection procedures, like concatenation. One skilled in the art will appreciate that these alterations do not exceed the scope of the disclosure.

The number of layers in an NN 800, choice of activation functions, inclusion of batch normalization layers, and regularization strength, among others, may be described as “hyperparameters” that are associated to the ML model. It is noted that in the context of ML, the regularization of a ML model refers to a penalty applied to the loss function of the ML model. The selection of hyperparameters associated to a ML model is commonly referred to as selecting the ML model “architecture.”

Once a ML model, such as an NN 800, and associated hyperparameters have been selected, the ML model may be trained. To do so, the training pairs as previously described may be provided to the NN 800. In general, each of the training pairs includes an input and an associated target output. Each associated target output represents the “ground truth,” or the otherwise desired output upon processing the input. During training, the NN 800 processes at least one input from an mth training pair, which is the associated mth training dispersion image, to produce at least one output. Each NN output is then compared to the associated target output from the mth training pair, which is the mth training seismic velocity profile.

Returning to the NN 800 in FIG. 8, the NN 800 may be trained by first assigning initial values to the edges 804. These values may be assigned randomly, according to a prescribed distribution, manually, or by some other assignment mechanism. Once edge values have been initialized, the NN 800 may act as a function such that it may receive an input from an mth training pair and produce an output. At least one input is propagated through the neural network 800 to produce an output.

The comparison of the NN output to the associated target output from the mth training pair is typically performed by a “loss function.” Other names for this comparison function include an “error function,” “misfit function,” and “cost function.” Many types of loss functions are available, such as the log-likelihood function or cross-entropy loss function. However, the general characteristic of a loss function is that the loss function provides a numerical evaluation of the similarity between the NN output and the associated target output from the mth training pair. The loss function may also be constructed to impose additional constraints on the values assumed by the edges 804. For example, a penalty term, which may be physics-based, or a regularization term may be added. Generally, the goal of a training procedure is to alter the edge values to promote similarity between the NN output and associated target output for most, if not all, of the M training pairs. Thus, the loss function is used to guide changes made to the edge values. This process is typically referred to as “backpropagation.”

While a full review of the backpropagation process exceeds the scope of this disclosure, a brief summary is provided. Backpropagation consists of computing the gradient of the loss function over the edge values. The gradient indicates the direction of change in the edge values that results in the greatest change to the loss function. Because the gradient is local to the current edge values, the edge values are typically updated by a “step” in the direction indicated by the gradient. The step size is often referred to as the “learning rate” and need not remain fixed during the training process. Additionally, the step size and direction may be informed by previous edge values or previously computed gradients. Such methods for determining the step direction are usually referred to as “momentum” based methods.

Once the edge values of the NN 800 have been updated through the backpropagation process, the NN 800 will likely produce different outputs than it did previously. Thus, the procedure of propagating at least one input from an mth training pair through the NN 800, comparing the NN output with the associated target output from the mth training pair with a loss function, computing the gradient of the loss function with respect to the edge values, and updating the edge values with a step guided by the gradient is repeated until a termination criterion is reached. Common termination criteria include, but are not limited to, reaching a fixed number of edge updates (otherwise known as an iteration counter), reaching a diminishing learning rate, noting no appreciable change in the loss function between iterations, or reaching a specified performance metric as evaluated on the training pairs or separate hold-out training pairs (denoted “validation pairs”). Once the termination criterion is satisfied, the edge values are no longer altered and the NN 800 is said to be “trained.”

Turning to a CNN, a CNN is similar to an NN 800 in that it can technically be graphically represented by a series of edges 804 and nodes 802 grouped to form layers. However, it is more informative to view a CNN as structural groupings of weights. Here, the term “structural” indicates that the weights within a group have a relationship, often a spatial relationship. CNNs are widely applied when the input also has a relationship. For example, a dispersion image, such as the associated mth training dispersion image 600, has a spatial relationship where the value associated to each pixel is spatially dependent on the value of other neighboring pixels within the dispersion image. Further, the velocity values of a seismic velocity profile, such as mth training seismic velocity profile 500, have a spatial relationship where a velocity value is spatially dependent on neighboring velocity values within the seismic velocity profile. Consequently, a CNN is an intuitive choice for processing dispersion images and seismic velocity profiles.

A structural grouping of weights is herein referred to as a “filter” or “convolution kernel.” The number of weights in a filter is typically much less than the number of inputs, where, now, each input may refer to a pixel in an image. For example, a filter may take the form of a square matrix, such as a 3×3 or 7×7 matrix. In a CNN, each filter can be thought of as “sliding” over, or convolving with, all or a portion of the inputs to form an intermediate output or intermediate representation of the inputs which possess a relationship. The portion of the inputs convolved with the filter may be referred to as a “receptive field.” Like the NN 800, the intermediate outputs are often further processed with an activation function. Many filters of different sizes may be applied to the inputs to form many intermediate representations. Additional filters may be formed to operate on the intermediate representations creating more intermediate representations. This process may be referred to as a “convolutional layer” within the CNN. Multiple convolutional layers may exist within a CNN as prescribed by a user.

There is a “final” group of intermediate representations, wherein no filters act on these intermediate representations. In some instances, the relationship of the final intermediate representations is ablated, which is a process known as “flattening.” The flattened representation may be passed to an RNN to produce a final output.

Like an NN 800, a CNN is trained. The filter weights and the edge values of the CNN, if present, are initialized and then determined using the training pairs and backpropagation as previously described.

Following the selection of the ML model and associated hyperparameters, training, and validation, the ML model may be deployed for use. In some embodiments, the ML model may be a CNN and an RNN placed in series. Further, in some embodiments, the architecture of the CNN may be similar to the architecture of the VGG16 CNN or ResNet50.

Prior to using the ML model, dispersion images may need to be determined. In some embodiments, each dispersion image may be determined by applying a transform (and possibly a filter) to the seismic traces 210 within each gather of the seismic data obtained from a subterranean region of interest 100 as previously described in FIG. 1.

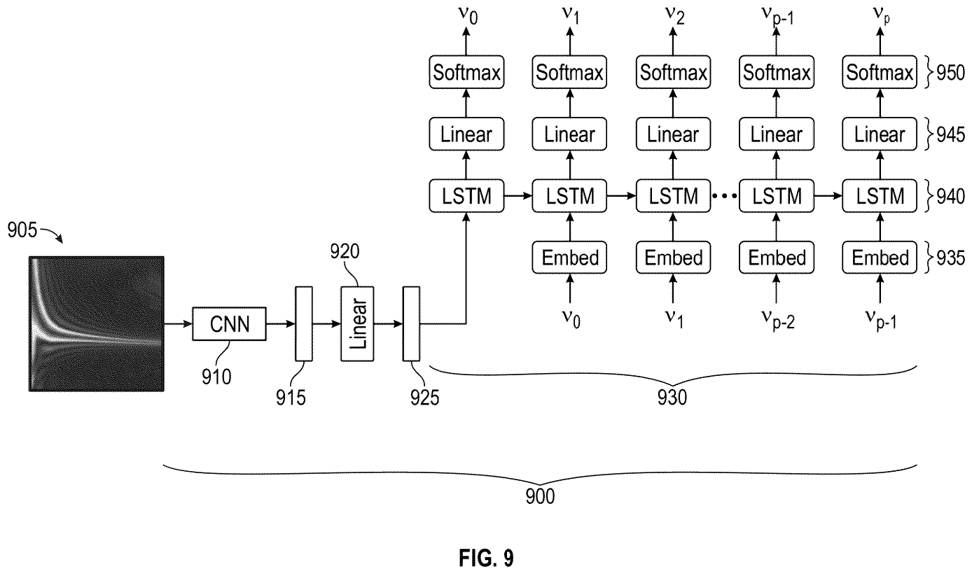

FIG. 9 illustrates an architecture of a ML model 900 in accordance with one or more embodiments. In these embodiments, a dispersion image 905 may be input into a CNN 910 to produce a dispersion image feature vector 915. The dispersion image feature vector 915 may be input into a linear layer 920 and/or a batch normalization layer (not shown) to produce an nth embedded image feature vector 925. Each element vₚ within the nth embedded image feature vector 925 may then be input into the RNN 930. In the embodiments illustrated in FIG. 9, the RNN 930 includes an embedding layer 935, LSTM layer 940, linear layer 945, and softmax layer 950.

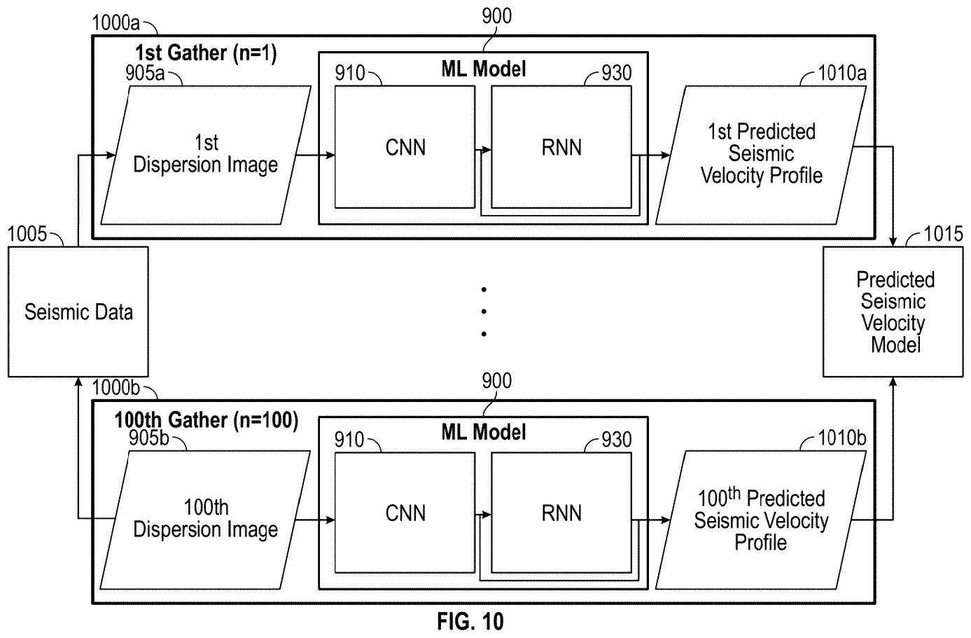

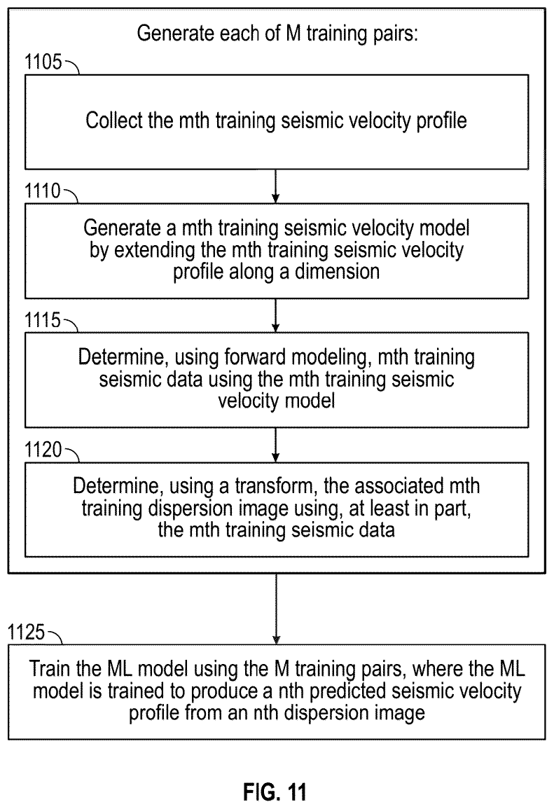

FIG. 10 illustrates a workflow for using a ML model 900 in accordance with one or more embodiments. For reference, the seismic data 1005 are sorted into 100 gathers in FIG. 10 for example though only the first gather 1000a and 100^{th} gather 1000b are shown for brevity. The first dispersion image 905a determined from the first gather 1000a may be input into the ML model 900. Here, the ML model 900 is illustrated as a CNN 910 and RNN 930 in series. As such, the ML model 900 may be considered an autoregressive process as shown by the feedback loop where the arrow that is output from the RNN 930 is input into the RNN 930. In some embodiments, the autoregressive process within the ML model 900 may produce the first predicted seismic velocity profile 1010a one velocity value at a time in series based on increasing depth. For example, the ML model 900 may produce a first velocity value at the first and most shallow depth 520 within the sequence of velocity values 510 within the first predicted seismic velocity profile 1010a. The first velocity value may then be input into the ML model 900 to produce a second velocity value at the second or deep depth 515 within the sequence of velocity values 510 within the first predicted seismic velocity profile 1010a. In some embodiments, the first velocity value and the second velocity value may be input into the ML model 900. In other embodiments, only the second velocity value may be input into the ML model 900. This process continues until the entire sequence of velocity values (i.e., the entire first predicted seismic velocity profile 1010a) is produced. This process may be considered a serial process.

Such a process may be repeated for the remaining dispersion images to determine the predicted seismic velocity profiles as illustrated for the 100^{th} dispersion image 905b and 100^{th} predicted seismic velocity profile 1010b only in FIG. 10. Each of these serial processes may be performed in parallel or in series without departing from the scope of the disclosure.

The predicted seismic velocity profiles, one per gather, may then be used to determine the predicted seismic velocity model 1015. In some embodiments, the predicted seismic velocity profiles may be concatenated or organized next to one another to determine the predicted seismic velocity model 1015.

FIG. 11 describes a method of training a ML model 900 in accordance with one or more embodiments. Steps 1105, 1110, 1115, and 1120 may be used to generate each of the training pairs. Recall that each of the training pairs includes an associated mth training synthetic dispersion image and an mth training seismic velocity profile. For example, the associated mth training synthetic dispersion image 600 displayed in FIG. 6 and the mth training seismic velocity profile 500 displayed in FIG. 5A may make up an mth training pair. In practice, tens to thousands of training pairs may be generated.

In step 1105, each mth training seismic velocity profile, such as the mth training seismic velocity profile 500, is collected. In some embodiments, each mth training seismic velocity profile is collected from a previously-determined seismic velocity model, such as the synthetic seismic velocity model 400 shown in FIG. 4. The seismic velocity model may be a seismic velocity model determined from a seismic survey, such as the seismic survey illustrated in FIG. 1, or a synthetic seismic velocity model. Each mth training seismic velocity profile may be collected along a unique line 425 that intersects the seismic velocity model as previously described relative to FIG. 4. Each mth training seismic velocity profile may be an S-wave seismic velocity profile, a P-wave seismic velocity profile, or combination thereof. In other embodiments, each mth training seismic velocity profile is determined by applying inversion to an mth dispersion image as previously described. Further, a model, such as Equation (1), may be applied to one or more previously-determined mth training seismic velocity profiles 705 to determine one or more additional mth training seismic velocity profiles 700 (i.e., data augmentation may be performed).

In step 1110, each mth training seismic velocity model is generated. Each mth training seismic velocity model, such as mth training seismic velocity model 525, may be generated by extending each mth training seismic velocity profile along a dimension. In some embodiments, the dimension may be a spatial dimension as shown in FIG. 5B.

In step 1115, the process of forward modeling may be applied to each mth training seismic velocity model to determine mth training synthetic seismic data as previously described. In some embodiments, the mth training synthetic seismic data may be filtered to include only mth training synthetic surface wave data if the mth training synthetic seismic data includes body wave information. Any method of filtering known to a person of ordinary skill in the art may be used, some of which have been previously described.

In step 1120, a transform is applied to the mth training synthetic seismic data to determine each associated mth training synthetic dispersion image, such as the associated mth training synthetic dispersion image 600. Any method of transformation known to a person of ordinary skill in the art may be used, some of which have been previously described herein.

In step 1125, the ML model 900 is trained using the training pairs. In some embodiments, the ML model 900 may be autoregressive as previously described. For example, in some embodiments, the ML model 900 may be or include an RNN 930 as described relative to FIGS. 8-10. In other embodiments, the ML model 900 may be a CNN 910 placed in series with an RNN 930 as illustrated in FIGS. 9 and 10. In some embodiments, training may be performed using backpropagation as previously described. In other embodiments, the ML model 900 may be previously trained, at least in part, such that transfer learning can be used to mitigate re-training challenges. The ML model 900 is trained to produce a predicted seismic velocity profile from a dispersion image as is described relative to FIG. 10.

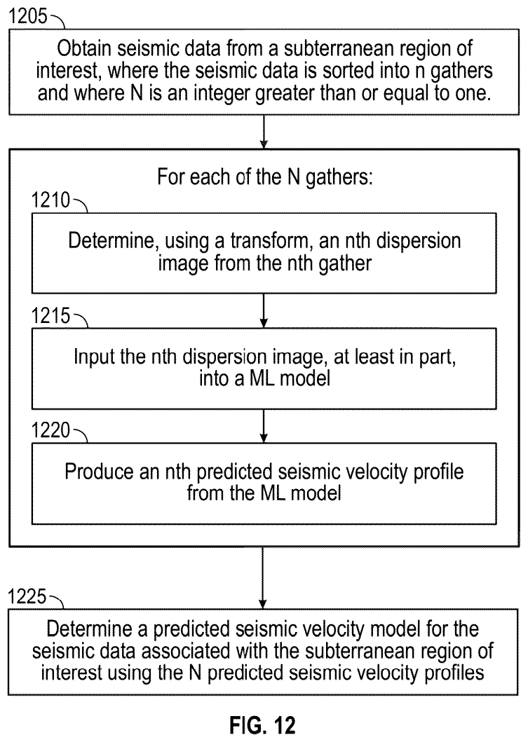

FIG. 12 describes a method of using the ML model 900 to determine a predicted seismic velocity model 1015 in accordance with one or more embodiments.

In step 1205, seismic data 1005 are obtained from a subterranean region of interest 100. In some embodiments, the seismic data 1005 are obtained from the subterranean region of interest 100 using a seismic acquisition system 105 as described in FIG. 1. The seismic data 1005 are sorted into gathers. The gathers may be any type of gather as described in FIGS. 2A-2E.

Steps 1210, 1215, and 1220 are performed for each gather either in series or in parallel. In step 1210, a dispersion image 905 is determined from each gather using a transform. Any method of transformation known to a person of ordinary skill in the art may be used, some of which have been previously described and need not be the same transform used in step 1120. Further, prior to applying the transform, the seismic data within each gather may be filtered such that only surface wave information (i.e., surface wave data) remains.

In step 1215, the dispersion image 905 is input into the ML model 900. If the ML model 900 is autoregressive, a previously-predicted velocity value for one or more shallow depths 520 within a previously-predicted seismic velocity profile may additionally be input into the ML model 900.

Further, in some embodiments, a previously-predicted velocity value for one or more shallow depths 520 may be binned into a velocity group within the ML model 900. The number of velocity groups may be predetermined. The range of velocity values associated to each velocity group may be based on the range of velocity values within the training seismic velocity profiles and the number of predetermined velocity groups. For example, assume the minimum velocity value and the maximum velocity value within the training seismic velocity profiles are 300 meters per second (m/s) and 650 m/s, respectively. Further assume that the number of predetermined velocity groups is 550. Thus, each velocity value range for each of the 550 velocity groups may be determined as:

$$\frac{750 - 200}{550} = 1 ,$$

to ensure all velocity values within the predicted seismic velocity profile and/or the validation pairs, which may extend beyond the minimum velocity value and maximum velocity value within the training seismic velocity profiles, are included. In turn, the velocity range for each of the 550 velocity groups is 1 m/s.

Returning to FIG. 12, in step 1220, the predicted seismic velocity profile is produced from the ML model 900.

In step 1225, a predicted seismic velocity model 1015 is determined using the predicted seismic velocity profile for each gather. In some embodiments, the predicted seismic velocity profiles may be organized along a dimension.

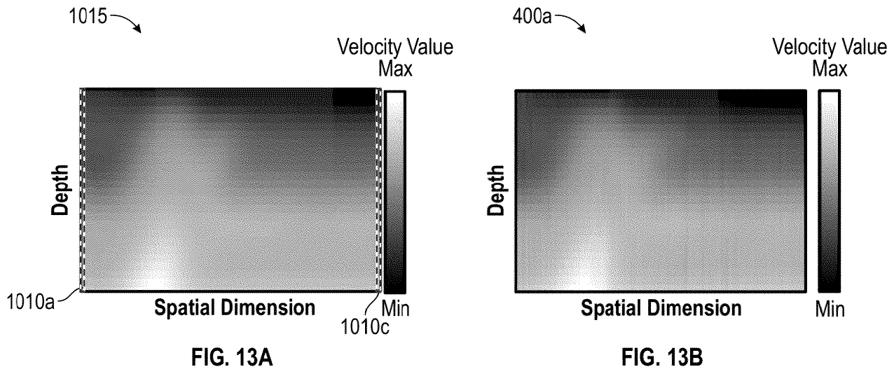

FIG. 13A displays a predicted seismic velocity model 1015 determined following the method described in FIG. 12. In FIG. 13A, tens to hundreds of seismic velocity profiles are produced from the ML model 900 including a first predicted seismic velocity profile 1010a and a last predicted seismic velocity profile 1010c, which may be a 100^{th} predicted seismic velocity profile 1010b. Note that FIG. 13A illustrates a predicted seismic velocity model 1015 for a portion of the subterranean region of interest 100 within the synthetic seismic velocity model 400 illustrated in FIG. 4 for comparison purposes. Further note that no part of the predicted seismic velocity model 1015 displayed in FIG. 13A is used for training the ML model 900. FIG. 13B illustrates the same portion of the synthetic seismic velocity model 400a as is shown in FIG. 13A. Upon visual inspection, the predicted seismic velocity model 1015 in FIG. 13A appears similar to the portion of the synthetic seismic velocity model 400a in FIG. 13B.

The method described in FIG. 12 may be repeated for the subterranean region of interest 100 over time to determine a real-time predicted seismic velocity model. In turn, a real-time predicted seismic velocity model may be used to continually monitor the structural integrity of the subterranean region of interest 100. In some embodiments, a real-time predicted seismic velocity model may be visually assessed for changes, such as motion of rock layers 115 and/or development or motion of holes and seepage zones. In other embodiments, a change point detection method may be used to quantify changes.

A real-time predicted seismic velocity model of the subterranean region of interest 100 may be particularly useful when the subterranean region of interest 100 supports a civil engineering structure. A civil engineering structure may include, but is not limited to, a walkway, road, railway 120, skiway, building, bridge, and dam. If motion of the subterranean region of interest 100 is detected based on the real-time predicted seismic velocity model, a recovery plan may be planned and executed to mitigate failure of the civil engineering structure. For example, if the real-time predicted seismic velocity model is used to detect motion in the subterranean region of interest 100 that supports a bridge, people using the bridge may be alerted to exit the bridge and the bridge may be closed for repair or re-routing. In another example, if the real-time predicted seismic velocity model is used to determine motion in the subterranean region of interest 100 that supports a dam, the dam may be reinforced and/or water re-routed to avoid catastrophic failure of the dam.

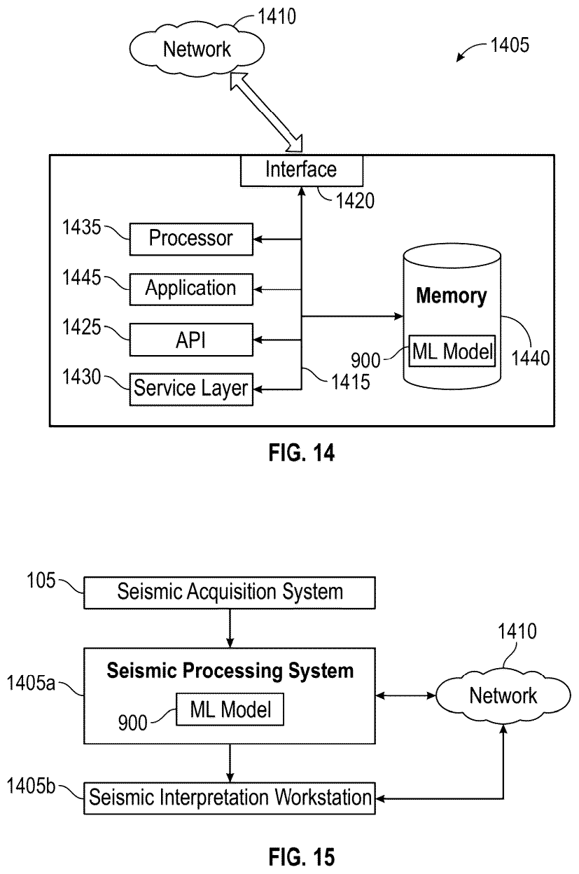

FIG. 14 illustrates a generic computer 1405 (hereinafter also “computer system”) in accordance with one or more embodiments. The computer 1405 may be specifically configured for seismic processing and denoted a “seismic processing system.” For example, each method described in FIGS. 11 and 12 may be performed on a seismic processing system. Alternatively, the computer 1405 may be specifically configured for seismic interpretation and denoted a “seismic interpretation workstation.” For example, assessing changes, such as motion within the subterranean region of interest 100, may be performed, at least in part, using a seismic interpretation workstation. While the generic term computer 1405 may be used to describe the parts of a computer 1405 in the following paragraphs, the terms seismic processing system or seismic interpretation workstation may replace the term computer 1405 without departing from the scope of the disclosure.

The computer 1405 is intended to depict any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1405 may include an input device, such as a keypad, keyboard, touch screen, or other device that can accept user information, and an output device that displays information, including digital data, visual or audio information (or a combination of both), or a graphical user interface. Specifically, a seismic interpretation workstation may include a robust graphics card for the detailed rendering of a predicted seismic velocity model 1015, including a real-time predicted seismic velocity model, such that the predicted seismic velocity model 1015 may be displayed and manipulated in a virtual reality system using 3D goggles, a mouse, or a wand to identify changes within the predicted seismic velocity model 1015 over time.

The computer 1405 can serve in a role as a client, network component, server, database, or any other component (or a combination of roles) of a computer system 1405 as required for seismic processing and seismic interpretation. The illustrated computer system 1405 is communicably coupled with a network 1410. For example, a seismic processing system and a seismic interpretation workstation may be communicably coupled using a network 1410. In some implementations, one or more components of each computer system 1405 may be configured to operate within environments, including cloud-computing-based, local, global, or other environment (or a combination of environments).

At a high level, the computer system 1405 is an electronic computing device operable to receive, transmit, process, store, and/or manage data and information associated with seismic processing and seismic interpretation. According to some implementations, the computer system 1405 may also include or be communicably coupled with an application server, e-mail server, web server, caching server, streaming data server, business intelligence (BI) server, or other server (or a combination of servers).

Because seismic processing and seismic interpretation may not be sequential, the computer system 1405 can receive requests over network 1410 from other computer systems 1405 or another client application and respond to the received requests by processing the requests appropriately. In addition, requests may also be sent to the computer system 1405 from internal users (for example, from a command console or by other appropriate access method), external or third-parties, other automated applications, as well as any other appropriate entities, individuals, systems, or computer systems 1405.

Each of the components of the computer system 1405 can communicate using a system bus 1415. In some implementations, any or all of the components of each computer system 1405, both hardware or software (or a combination of hardware and software), may interface with each other or the interface 1420 (or a combination of both) over the system bus 1415 using an application programming interface (API) 1012 or a service layer 1430 (or a combination of the API 1425 and service layer 1430. The API 1425 may include specifications for routines, data structures, and object classes. The API 1425 may be either computer-language independent or dependent and refer to a complete interface, a single function, or even a set of APIs. The service layer 1430 provides software services to each computer system 1405 or other components (whether or not illustrated) that are communicably coupled to each computer system 1405. The functionality of each computer system 1405 may be accessible for all service consumers using this service layer 1430. Software services, such as those provided by the service layer 1430, provide reusable, defined business functionalities through a defined interface. For example, the interface may be software written in JAVA, C++, or other suitable language providing data in extensible markup language (XML) format or another suitable format. While illustrated as an integrated component of each computer system 1405, alternative implementations may illustrate the API 1425 or the service layer 1430 as stand-alone components in relation to other components of each computer system 1405 or other components (whether or not illustrated) that are communicably coupled to each computer system 1405. Moreover, any or all parts of the API 1425 or the service layer 1430 may be implemented as child or sub-modules of another software module, enterprise application, or hardware module without departing from the scope of this disclosure.

The computer system 1405 includes an interface 1420. Although illustrated as a single interface 1420 in FIG. 14, two or more interfaces 1420 may be used according to particular needs, desires, or particular implementations of each computer system 1405. The interface 1420 is used by each computer system 1405 for communicating with other systems in a distributed environment that are connected to the network 1410. Generally, the interface 1420 includes logic encoded in software or hardware (or a combination of software and hardware) and operable to communicate with the network 1410. More specifically, the interface 1420 may include software supporting one or more communication protocols associated with communications such that the network 1410 or interface's hardware is operable to communicate physical signals within and outside of the illustrated computer 1405.

The computer system 1405 includes at least one computer processor 1435. Generally, a computer processor 1435 executes any instructions, algorithms, methods, functions, processes, flows, and procedures as described in the instant disclosure. A computer processor 1435 may be a central processing unit (CPU) and/or a graphics processing unit (GPU). Each of the seismic data 1005, the synthetic seismic velocity model 400, and the predicted seismic velocity model 1015 may be hundreds of terabytes in size. To efficiently process the seismic data 1005 and determine the predicted seismic velocity model 1015, a seismic processing system may consist of an array of CPUs with one or more subarrays of GPUs attached to each CPU. Further, tape readers or high-capacity hard-drives may be connected to the CPUs using wide-band system buses 1415.

The computer system 1405 also includes a memory 1440 that stores data and software for the computer system 1405 or other components (or a combination of both) that can be connected to the network 1410. Although illustrated as a single memory 1440 in FIG. 14, two or more memories may be used according to particular needs, desires, or particular implementations of the computer system 1405 and the described functionality. While memory 1440 is illustrated as an integral component of each computer system 1405, in alternative implementations, memory 1440 can be external to each computer system 1405.

The application 1445 is an algorithmic software engine providing functionality according to particular needs, desires, or particular implementations of the computer system 1405, particularly with respect to functionality described in this disclosure. For example, application 1445 can serve as one or more components, modules, applications, etc. Further, although illustrated as a single application 1445, the application 1445 may be implemented as multiple applications 1445 on each computer system 1405. In addition, although illustrated as integral to each computer system 1405, in alternative implementations, the application 1445 can be external to each computer system 1405.

There may be any number of computers 1405 associated with, or external to, a seismic processing system and a seismic interpretation workstation, where each computer system 1405 communicates over network 1410. Further, the term “client,” “user,” and other appropriate terminology may be used interchangeably as appropriate without departing from the scope of this disclosure. Moreover, this disclosure contemplates that many users may use the computer system 1405, or that one user may use multiple computer systems 1405.

Turning to FIG. 15, FIG. 15 illustrates a summary of systems in accordance with one or more embodiments. In some embodiments, the seismic acquisition system 105 may be configured to obtain the seismic data 1005 from a subterranean region of interest 100. Further, the seismic acquisition system 105 may be configured to obtain other seismic data from the same or one or more other subterranean regions of interest 100. The seismic data 1005 and other seismic data may be input into, stored on, and processed using the seismic processing system 1405a.

The seismic processing system 1405a may be configured to process the seismic data 1005 and the other seismic data. Seismic processing may include attenuating artifacts and amplifying manifestations of features, such as geological boundaries 110, within the subterranean regions of interest 100. The seismic processing system 1405a may be further configured to determine a seismic velocity model, such as the synthetic seismic velocity model 400, from the other seismic data. In turn, in some embodiments, the method of training the ML model 900 as described relative to FIG. 11 may be performed by the seismic processing system 1405a. As such, the ML model 900 may be stored on a memory 1440 of the seismic processing system 1405a as illustrated in FIG. 14.

Following the method described in FIG. 11, the seismic processing system 1405a may be further configured to perform the method of determining the predicted seismic velocity model 1015 as described relative to FIG. 12.

The predicted seismic velocity model 1015 may be transferred to and stored on the seismic interpretation workstation 1405b via the network 1410 as described relative to FIG. 14. The predicted seismic velocity model 1015 may then be displayed on the seismic interpretation workstation 1405b. In some embodiments, the real-time predicted seismic velocity model may be automatically updated and displayed on the seismic interpretation workstation 1405b. The predicted seismic velocity model 1015 and/or the real-time predicted seismic velocity model displayed on the seismic interpretation workstation 1405b may look similar to the predicted seismic velocity model 1015 shown in FIG. 13A. In some embodiments, a seismic interpreter may manually monitor the predicted seismic velocity model 1015 and/or the real-time predicted seismic velocity model using the seismic interpretation workstation 1405b to identify changes within the subterranean region of interest 100. In other embodiments, a change point detection method may be used to automatically monitor the predicted seismic velocity model 1015 and/or the real-time predicted seismic velocity model to detect changes within the subterranean region of interest 100. In some embodiments, changes may indicate motion of the subterranean region of interest 100. If changes within the subterranean region of interest 100 are identified or detected, a recovery plan may be planned and executed to mitigate failure of a civil engineering structure that is supported by the subterranean region of interest 100.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of training a machine learning (ML) model comprising:
generating a plurality of training pairs,
wherein each of the plurality of training pairs comprises an mth training seismic velocity profile and an associated mth training synthetic dispersion image,
wherein m is a count of the plurality of training pairs, and
wherein generating the plurality of training pairs comprises:
collecting the mth training seismic velocity profile;
generating an mth training seismic velocity model by extending the mth training seismic velocity profile along a dimension;
determining, using forward modeling, mth training synthetic seismic data using the mth training seismic velocity model; and
determining, using a transform, the associated mth training synthetic dispersion image using, at least in part, the mth training synthetic seismic data; and
training the ML model using the plurality of training pairs,
wherein the ML model is trained to produce a predicted seismic velocity profile from a dispersion image.

2. The method of claim 1, wherein collecting the mth training seismic velocity profile comprises:
collecting seismic data,
wherein the seismic data is sorted into a plurality of gathers; and
for each gather among the plurality of gathers:
determining, using the transform, an mth dispersion image from each gather, and
determining, using inversion, the mth training seismic velocity profile from the mth dispersion image.

3. The method of claim 1, further comprising determining, using a model, an (m+1)th training seismic velocity profile from the mth training seismic velocity profile.

4. The method of claim 1, further comprising:
separating validation pairs from the plurality of training pairs; and
evaluating, using a cross-entropy loss function, the ML model on the validation pairs.

5. The method of claim 1, wherein the mth training seismic velocity profile comprises an mth training shear-wave seismic velocity profile and an mth training compressional-wave seismic velocity profile.

6. The method of claim 1, wherein the associated mth training synthetic dispersion image comprises a three-dimensional associated mth training synthetic dispersion image.

7. The method of claim 1, wherein the ML model comprises a convolutional neural network (CNN) and a recurrent neural network (RNN).

8. The method of claim 7, wherein the RNN uses an autoregressive process.

9. The method of claim 1, wherein training the ML model comprises:
defining a plurality of velocity groups; and
defining each velocity value within the mth training seismic velocity profile by one of the plurality of velocity groups.

10. A method of determining a predicted seismic velocity model comprising:
obtaining seismic data from a subterranean region of interest,
wherein the seismic data is sorted into a plurality of gathers;
for each gather among the plurality of gathers:
determining, using a transform, a dispersion image from each gather,
inputting the dispersion image, at least in part, into a machine learning (ML) model,
wherein the ML model is trained to produce a predicted seismic velocity profile from the dispersion image, and
producing the predicted seismic velocity profile from the ML model based, at least in part, on the dispersion image; and
determining the predicted seismic velocity model for the seismic data associated with the subterranean region of interest using the predicted seismic velocity profile for each gather.

11. The method of claim 10, further comprising:
determining, using a seismic interpretation workstation and a change point detection method, a motion of the subterranean region of interest based, at least in part, on the predicted seismic velocity model.

12. The method of claim 11, further comprising:
determining a recovery plan of a civil engineering structure supported by the subterranean region of interest based, at least in part, on the motion of the subterranean region of interest; and
executing the recovery plan.

13. The method of claim 10, wherein training the ML model comprises:
generating a plurality of training pairs,
wherein each of the plurality of training pairs comprises an mth training seismic velocity profile and an associated mth training synthetic dispersion image,
wherein m is a count of the plurality of training pairs, and
wherein generating the plurality of training pairs comprises:
collecting the mth training seismic velocity profile;
generating an mth training seismic velocity model by extending the mth training seismic velocity profile along a dimension;
determining, using forward modeling, mth training synthetic seismic data using the mth training seismic velocity model; and
determining, using the transform, the associated mth training synthetic dispersion image using, at least in part, the mth training synthetic seismic data; and
training the ML model using the plurality of training pairs.

14. The method of claim 10, wherein determining the dispersion image comprises:
determining surface wave data from each gather; and
determining, using the transform, the dispersion image from the surface wave data.

15. The method of claim 10, wherein the ML model comprises a convolutional neural network (CNN) and a recurrent neural network (RNN).

16. The method of claim 10, wherein the predicted seismic velocity profile comprises a sequence of predicted velocity values organized by increasing depth,
wherein the sequence of predicted velocity values comprises a shallow predicted velocity value followed by a deep predicted velocity value, and
wherein producing the predicted seismic velocity profile comprises:
for each of the sequence of predicted velocity values in order:
inputting the dispersion image and the shallow predicted velocity value into the ML model;
producing the deep predicted velocity value from the ML model based, at least in part, on the dispersion image; and
re-assigning the deep predicted velocity value as the shallow predicted velocity value.

17. The method of claim 10, wherein the subterranean region of interest supports a civil engineering structure.

18. A system comprising:
a seismic processing system configured to:
receive seismic data from a subterranean region of interest,
wherein the seismic data is sorted into a plurality of gathers, and
for each gather among the plurality of gathers:
determine, using a transform, a dispersion image from each gather; and
a machine learning (ML) model configured to:
for each gather among the plurality of gathers:
accept the dispersion image; and
produce a predicted seismic velocity profile based, at least in part, on the dispersion image;
wherein the seismic processing system is further configured to:
determine a predicted seismic velocity model for the seismic data associated with the subterranean region of interest using the predicted seismic velocity profile for each gather.

19. The system of claim 18, further comprising a seismic interpretation workstation configured to determine a motion of the subterranean region of interest based, at least in part, on the predicted seismic velocity model.

20. The system of claim 18, further comprising a seismic acquisition system configured to obtain the seismic data.
